(19) United States
(12) Patent Application Publication
(10) Pub. No.: US 2012/0109729 A1
(43) Pub. Date: May 3, 2012

(54) SYSTEM FOR MANAGING A LOYALTY PROGRAM

(75) Inventor: Jay W. Hoffmann, Wilmette, IL (US)

(73) Assignee: Mileage Plus Holdings, LLC, Chicago, IL (US)

(21) Appl. No.: 12/914,516

(22) Filed: Oct. 28, 2010

(51) Int. Cl. G06Q 30/00; G06Q 40/00

(52) U.S. Cl. 705/14.17; 705/14.33

(57) ABSTRACT

Some embodiments include a method comprising detecting, by one or more banking servers, selection of an investment product, wherein the investment product pays interest according to terms of the investment product. The method can also include selling the investment product, wherein the selling includes: 1) receiving personal information about a purchaser of the investment product, wherein the personal information identifies a loyalty program account receiving, by the one or more banking servers, payment information indicating payment was received for the investment product, and 2) determining, by the one or more banking servers, an interest value for the investment product based on the terms of the investment product. The method can also include requesting transfer of loyalty currency into the loyalty program account, wherein the loyalty currency is valued at the interest value, and wherein the requesting transfer is performed by the one or more banking servers.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2010, Mileage Plus Holdings, LLC.

### FIELD

Embodiments of the inventive subject matter relate generally to data processing systems, more particularly to the systems for administering loyalty programs.

### BACKGROUND

Many airlines have loyalty programs. Such loyalty programs typically award consumers with frequent-flier miles (also referred to as “miles”, “points”, etc.) when they purchase airline tickets, and other goods and services. Consumers can redeem the frequent-flier miles for additional airline tickets, rental cars, hotel stays, and more. Thus, frequent-flier miles are like “credits” for use in purchasing airline tickets, and other goods and services. Typically, frequent-flier miles are only redeemable at one airline (i.e., the airline that awarded the miles). As consumers accrue and redeem miles with a particular airline, the consumers typically develop loyalty to that airline. As a result, airline loyalty programs are constantly looking for new and creative ways to award and redeem frequent-flier miles.

### BRIEF DESCRIPTION OF THE FIGURES

Some embodiments of the inventive subject matter are illustrated in the Figures of the accompanying drawings in which:

FIG. 1 is a conceptual diagram illustrating how some embodiments of the inventive subject matter pay interest on an investment in units of loyalty currency.

FIG. 2 is a block diagram illustrating a loyalty program network, according to embodiments of the invention.

FIG. 3 is a data flow diagram illustrating components and operations for selling investment products that pay interest as loyalty currency.

FIG. 4 is a data flow diagram illustrating components and operations for redeeming loyalty currency, according to some embodiments of the invention.

FIG. 5 is a flow diagram illustrating operations for configuring investment products that pay interest as loyalty currency, according to some embodiments of the invention.

FIG. 6 shows a graphical user interface for configuring investment products that pay loyalty currency as interest, according to some embodiments of the invention.

FIG. 7 is a flow diagram illustrating operations for selling investment products, according to some embodiments of the invention.

FIG. 8 is a flow diagram illustrating operations for delivering messages based on airline information and information associated with a loyalty program.

FIG. 9 illustrates a boarding pass that includes a message from a benefactor or other social contact.

### DESCRIPTION OF THE EMBODIMENTS

This document describes inter alia systems and operations for paying investment interest in the form of loyalty currency. The following discussion is divided into five sections. The first section introduces some embodiments of the inventive subject matter, while the second section describes an example operating environment (e.g., components, systems, etc.). The third section describes operations of some embodiments, and the fourth section describes some additional embodiments. The fifth section provides some general comments.

### Introduction

Typically, loyalty programs award loyalty currency on a “per transaction” basis. For example, a loyalty program may award loyalty currency when a consumer does any of the following: 1) purchases airline tickets, 2) makes purchases on a credit card that is associated with the loyalty program, 3) purchases rental cars though loyalty program promotions, 4) purchases hotel stays through loyalty program promotions, etc. Therefore, if consumers want to accrue more loyalty currency, they must continuously enter into various transactions. Some consumers may find transaction-based loyalty programs cumbersome or otherwise unappealing.

Some embodiments of the inventive subject matter enable loyalty programs to offer opportunities for earning loyalty currency without continuously entering transactions. According to some embodiments, consumers can purchase interest-bearing investment products tied to a loyalty program, where the investment products periodically pay interest in the form of loyalty currency. Such embodiments enable consumers to periodically receive loyalty currency based on a single purchase (i.e., the purchase of the investment product). The investment product can be an annuity, an interest-bearing investment account, etc. Because some embodiments facilitate payment of investment interest as loyalty currency, consumers can address their travel needs as part of an overall investment strategy.

In some instances, consumers may want to give away loyalty currency to help others travel. For example, parents may want to give loyalty currency to their children. Some embodiments of the inventive subject matter enable consumers to purchase investment products that pay loyalty currency to beneficiaries. Thus, parents can purchase certificates of deposit (or other investment products) that pay loyalty currency to their children. In turn, the children can use the loyalty currency for travel and other goods and services. When gifted loyalty currency is redeemed, some embodiments facilitate messaging between benefactors and beneficiaries (e.g., parents and children). For example, when a child prints a boarding pass, the boarding pass may include a message from a parent. Such messaging can provide satisfaction to benefactors and generally enhance travel experiences.

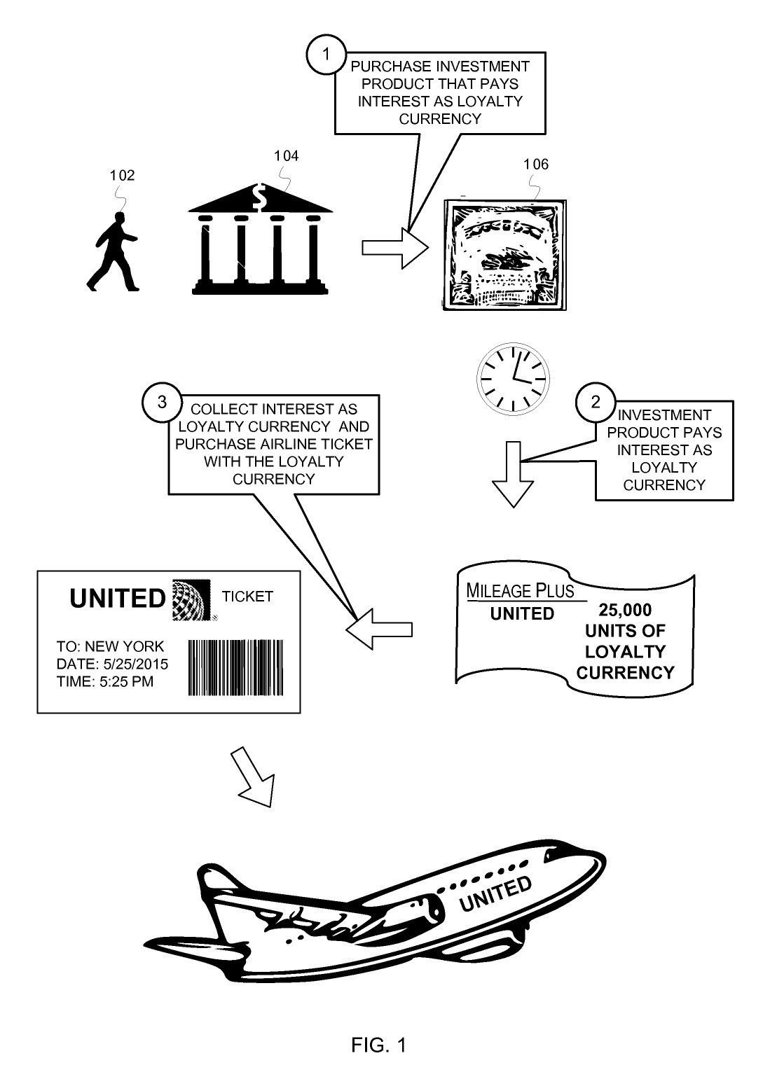

FIG. 1 is a conceptual diagram illustrating how some embodiments of the inventive subject matter pay interest on an investment in units of loyalty currency. As shown, a consumer 102 can enter a bank 104 to purchase investment products 106 (see stage 1), such as annuities, certificates of deposit, etc. The bank 104 can offer a line of investment products that pays interest in the form of loyalty currency for a loyalty program. For example, the bank 104 may sell the consumer 102 a five-year annuity for $10,000 at 3% interest. Each year, according to the terms of the annuity, the bank 104 may pay the consumer 102 some cash (e.g., $2000), and some loyalty currency (e.g., 25,000 units of loyalty currency).

After purchasing the investment product, the consumer 102 leaves the bank 104, and waits for interest to accrue under the terms of the investment product (see stage 2). Under the terms, interest is paid as loyalty currency. Thus, after interest accrues, the consumer 102 collects the loyalty currency and uses it to purchase airline tickets (see stage 3).

The following sections provide additional details about these and other embodiments of the inventive subject matter.

### Operating Environment

This section describes an example operating environment and provides structural aspects of some embodiments.

### Loyalty Program Network

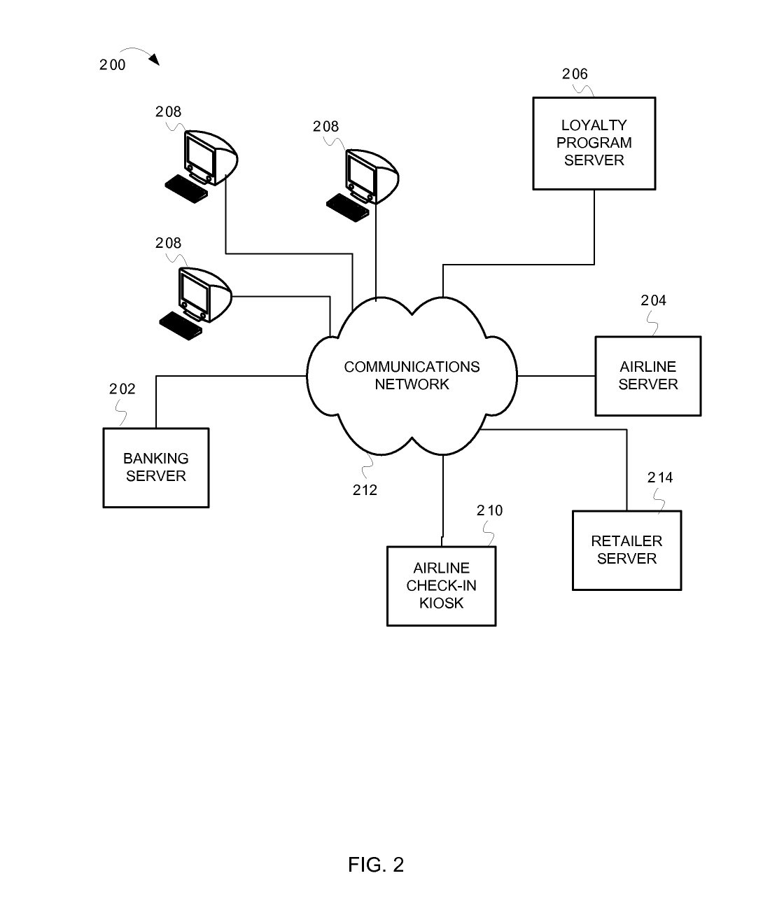

FIG. 2 is a block diagram illustrating a loyalty program network, according to embodiments of the invention. In FIG. 2, the loyalty program network 200 includes a communications network 212 connected to a banking server 202, airline server 204, loyalty program server 206, airline check-in kiosk 210, retailer server 214, and consumer computers 208.

The banking server 202 processes information related to investment products that pay interest in the form of loyalty currency. A bank or other financial service institution may own and operate the banking server 202. The loyalty program server 206 processes information related to members of the loyalty program, such as an airline's loyalty program. An airline or an independent loyalty program may own and operate the loyalty program server 206. The airline server 204 and retailer server 214 process information related to redeeming loyalty currency. The airline check-in kiosk 210 processes information related to passengers checking-in for airline flights. An airline may own and operate the airline server 204 and airline check-in kiosk 210. A retailer or service provider may own and operate the retailer server 214.

As described in further detail in the next section (see below), the components 202-212 facilitate sales of investment products that pay interest in the form of loyalty currency. The loyalty currency is redeemable for airline tickets, rental cars, hotel stays, consumer goods and services, etc. The components also enable consumers to give away loyalty currency, and receive other benefits.

The network 212 can be a local area network (LAN) or a wide area network (WAN). The communications network 212 can include any suitable technology, such as Public Switched Telephone Network (PSTN), Ethernet, 802.11g, SONET, Digital Subscriber Line (DSL), Hybrid Fibre-Coaxial (HFC) network, etc. Additionally, the components 202, 204, 206, 208, 210, & 214 can connect (via hardware and/or software components) to the communications network 212 and exchange data with other devices in the loyalty program network 200 or other networks (not shown). In some embodiments, the servers and consumer computers include technologies for utilizing the world wide web. For example, any of the components in FIG. 2 can include web browsers, web servers, and other web technologies.

The consumer computers 208, servers 202, 204, 206 & 214, and kiosk 210 can include any suitable computing devices, such as mainframe computers, blade computers, minicomputers, personal computers, etc. However, in some instances, one or more of the components 202, 204, 206, 210 & 214 can be implemented as software executing on a computing device. Thus, in some instances, a plurality of the components 202, 204, 206, 208, 210, & 214 can run on a single computing device.

Although the network includes only one of each of the components 202, 204, 206 210 & 214, some embodiments include a plurality of these components. Furthermore, any of these components can be subdivided. For example, in some embodiments, a plurality of banking servers 202 work together to perform the operations described herein.

In some embodiments, one or more of the components 202, 204, 206, 208, 210, & 214 include machine-readable storage media including instructions for performing operations described herein. Machine-readable storage media includes any tangible mechanism that provides (e.g., stores and transmits) information in a form readable by a machine (e.g., a computer system). For example, machine-readable storage media includes semiconductor read only memory (ROM), semiconductor volatile random access memory (RAM), magnetic disk storage media, optical storage media, non-volatile flash memory devices, etc.

### Example Operations

This section describes operations associated with some embodiments of the invention. In certain embodiments, the operations are performed by executing instructions residing on machine-readable storage media (e.g., software), while in other embodiments, the operations are performed by hardware and/or other components (e.g., firmware). In some embodiments, the operations are performed in series, while in other embodiments, one or more of the operations can be performed in parallel. Moreover, some embodiments perform less than all the operations shown in the flow diagrams.

### Sale and Redemption

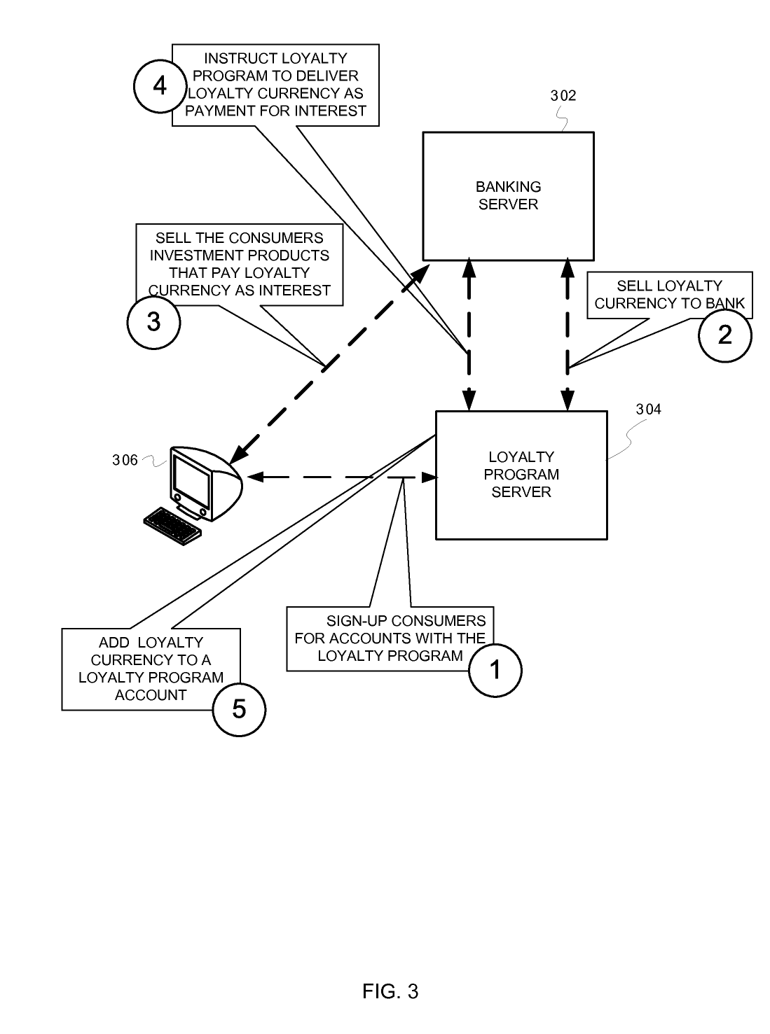

FIG. 3 is a data flow diagram illustrating components and operations for selling investment products that pay interest as loyalty currency. In FIG. 3, the components include a consumer computer 306, loyalty program server 304, and banking server 302. In FIG. 3, operations occur in five stages.

During stage 1, the loyalty program server 304 signs-up consumers for accounts with a loyalty program. In some instances, consumers go to a webpage hosted by the loyalty program server 304. Using the webpage, consumers provide personal information needed for creating an account with a loyalty program. In turn, the server 304 creates a loyalty program account for the consumers. The loyalty program account enables the consumers to accrue and redeem loyalty currency.

During stage 2, the loyalty program sells loyalty currency to a bank or other financial services institution. In some instances, the loyalty program sells loyalty currency to the bank at a price lower than it sells loyalty currency to consumers. Thus, the bank can use the lower price to create attractive investment products. The loyalty program server 304 and banking server 302 can conduct this sale electronically. In some instances, the loyalty program server 304 creates an administrative account for the bank, and then deposits any purchased loyalty currency into the administrative account. Later, the bank can electronically transfer loyalty currency to consumer accounts as interest payments for investment products. Thus, the servers 302 & 304 exchange information about the sale of loyalty currency.

During stage 3, the bank sells consumers investment products that pay interest as loyalty currency. For example, a bank may sell a $1000 certificate of deposit that has a 3% interest rate and one-year term. When the certificate of deposit matures, the bank will pay the 3% interest in loyalty currency. In some instances, the bank sells investment products via a webpage (see FIG. 3). In other instances, the bank sells investment products to consumers who come into the bank (i.e., the point of sale is at the bank). Regardless of the point of sale, the banking server 302 records information about the sale, such as: 1) consumer information including name, address, etc., 2) terms of the investment product, such as investment amount, interest rate, duration, etc. and 3) the consumer's loyalty account information.

During stage 4, after interest accrues under the terms of the investment product, the bank pays the interest as loyalty currency. Thus, during stage 4, the banking server 302 instructs the loyalty program server 304 to deposit a specific amount of loyalty currency into the consumer's loyalty program account. In response to this request, the loyalty program server 304 deposits the loyalty currency in the consumer's loyalty program account (see stage 5).

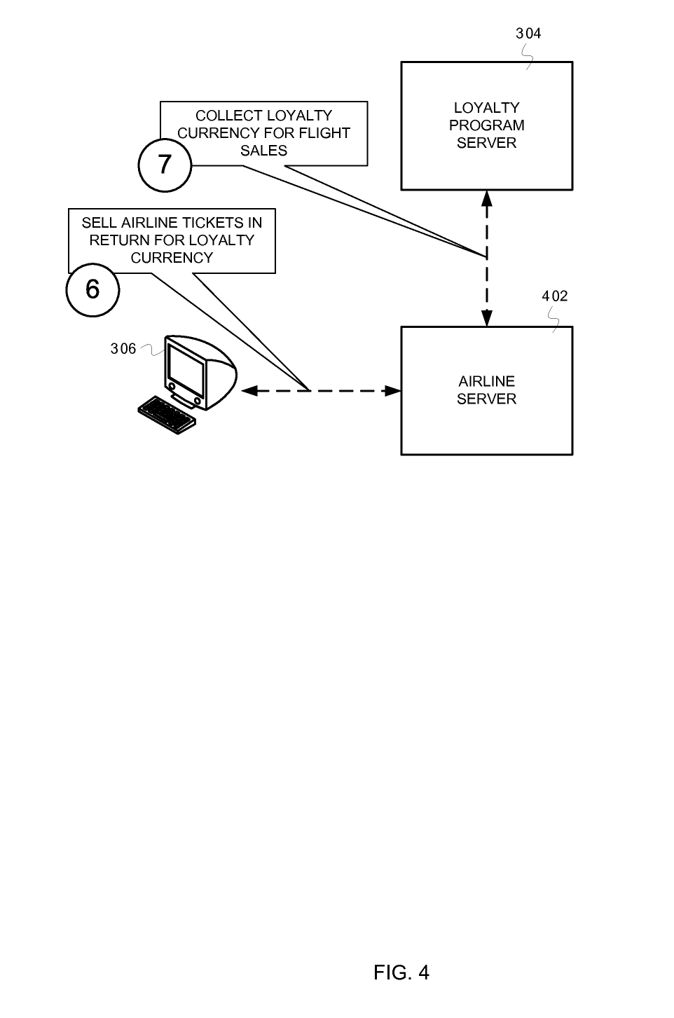

While FIG. 3 describes operations for selling investment products that pay interest as loyalty currency, the discussion continues with operations for redeeming loyalty currency. FIG. 4 is a data flow diagram illustrating components and operations for redeeming loyalty currency, according to some embodiments of the invention. After consumers acquire loyalty currency via FIG. 3's stages 1-5, they can redeem loyalty currency in FIG. 4's stages 6-7. In FIG. 4, the consumer computer 306 (from FIG. 3) and loyalty program server 304 (from FIG. 3) interact with an airline server 402.

During stage 6, an airline sells airline tickets in return for loyalty currency. The airline server 402 may facilitate the sale via a webpage. That is, the airline server 402 may host a webpage at which consumers can purchase airline tickets. Alternatively, the airline server 402 may be connected to computers at a ticket counter or other point-of-sale. In any case, the airline server 402 records information indicating a ticket sale (e.g., flight information, pricing, etc.).

During stage 7, the airline server 402 collects loyalty currency or other value from the loyalty program server 304. For example, the airline server 402 debits loyalty currency from a consumer's loyalty program account to pay for the airline tickets. In other embodiments, instead of debiting loyalty currency, the airline server 402 may receive cash or other value from the loyalty program server 304. In any case, the components enable consumers to pay for airline tickets using loyalty currency.

Instead of using loyalty currency for purchasing airline tickets, consumers can use loyalty currency to purchase other goods and services, such as rental cars, hotel stays, consumer products, etc. In some instances, the airline server 402 facilitates loyalty currency redemption for goods and services not offered by the airline. However, in other instances, other computers can interact with the loyalty program server 304 to facilitate loyalty currency redemption. For example, in some embodiments, a retailer server may interact with the loyalty server 402 in a process for redeeming loyalty currency for consumer goods. The retail server can be connected to computers at various points of sale, such as cash registers in retail stores, computing devices on the internet via webpages, etc. As part of completing consumer transactions, the retail server can interact with the loyalty program server 304 to determine whether a consumer has enough loyalty currency to complete a transaction, and to collect payment for the transaction from the loyalty server 402. In turn, the loyalty server 402 can debit the consumer's loyalty account to reflect the purchase.

This section continues with details about configuring investment products that pay interest as loyalty currency.

### Configuring Investment Products

In the discussion above, “banks” sell the investment products that bear interest in the form of loyalty currency. However, in some embodiments, the investment products may be sold by any suitable financial institution, such as traditional brokerages, discount brokers, online brokers, etc. Thus, references to “banks” and “banking servers” are intended to include other financial institutions, and servers for such financial institutions. According to some embodiments, before these financial institutions can offer investment products for sale, they must configure the products.

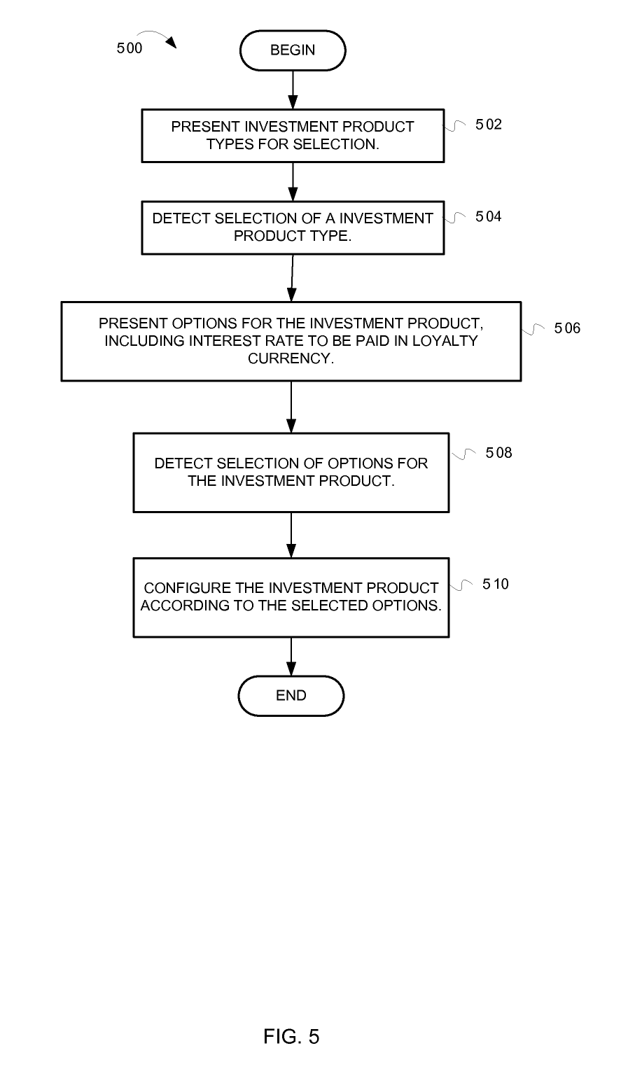

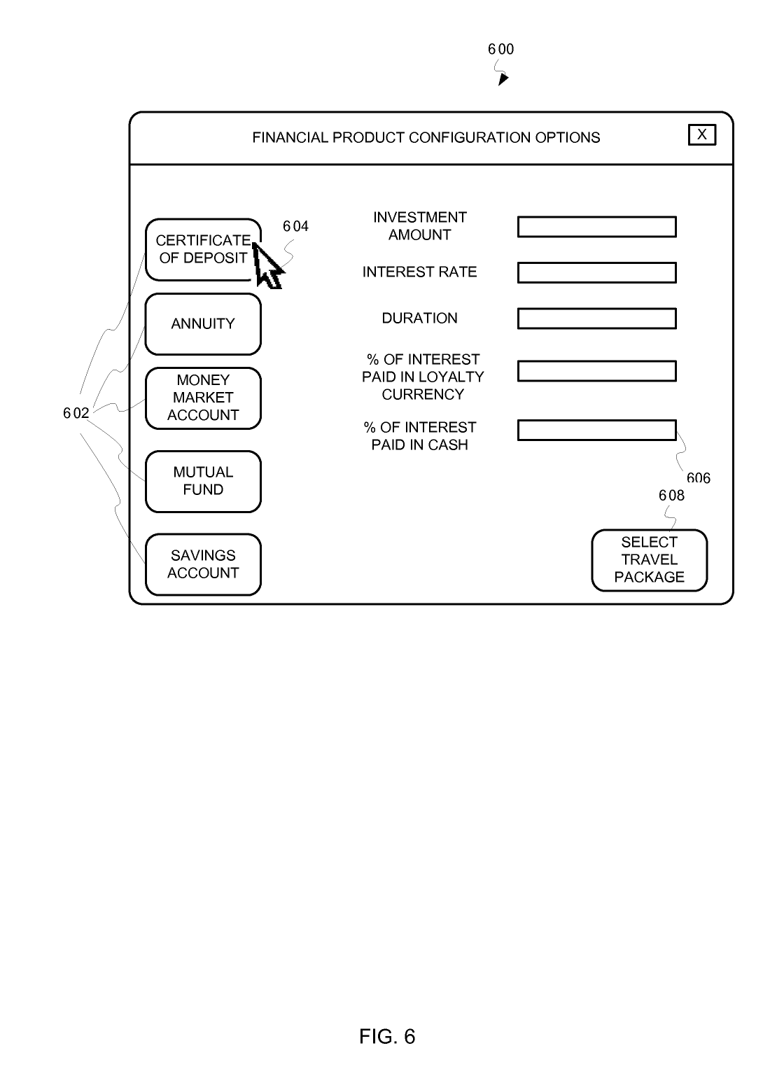

FIG. 5 is a flow diagram illustrating operations for configuring investment products that pay interest as loyalty currency, according to some embodiments of the invention. The operations of FIG. 5 will be described in concert with FIG. 6, which shows a graphical user interface for configuring investment products that pay interest as loyalty currency. In FIG. 5, operational flow begins at block 502.

At block 502, a banking server presents investment product types for selection in a user interface. FIG. 6 shows an example user interface 600 including icons 602 representing various investment product types. The types include certificates of deposit, annuities, money market accounts, mutual funds, and savings accounts. The flow 500 continues at block 504.

At block 504, the banking server detects selection of an investment product type. In some instances (see FIG. 6), the banking server detects user input from a bank administrator, where the input indicates selection of an icon 602 corresponding to an investment product (see mouse cursor 604). The flow 500 continues at block 506.

At block 506, the banking server presents options for the investment product. As shown in FIG. 6, the options can include interest rate, duration, investment amount, percentage of interest paid in loyalty currency, and percentage of interest paid in cash. The options may also include a value for loyalty currency earned as interest. For example, the banking server may allow administrators to assign loyalty currency a value that will apply throughout the life of the investment product. Alternatively, the banking server may allow administrators to stipulate that the loyalty currency will be valued according to market rates at the time the interest accrues. The flow 500 continues at block 508.

At block 508, the banking server detects selection of options for the investment product. In some instances, administrators enter option information in the option fields 606, as shown in FIG. 6. In other instances, the banking server provides drop-down menus from which options are selected. The flow continues at block 510.

At block 510, the banking server configures the investment product according to the selected options. For example, the banking server may configure a certificate of deposit for a selected amount (e.g., $10,000), paying interest at a selected rate (e.g., 3%), over a selected time (2 years), etc. After configuring investment products, the bank can offer the products for sale to consumers. From block 510, the flow ends.

In some embodiments, instead of paying interest in the form of loyalty currency, the banking server can specify particular travel packages to be provided after interest has accrued. Narrowing travel choices may help some consumers, such as those who do not know much about travel, those who have trouble making choices, etc. In FIG. 6, a bank administrator can activate the “select travel package” button 608 to configure a particular travel package to be provided after interest accrues. For example, a travel package may include hotel accommodations at a destination, rental car, day tours, and other travel goods and services.

### More About Sales

This section continues by describing how processes for selling investment products may be augmented to register consumers for loyalty programs, configure gifting options, and more.

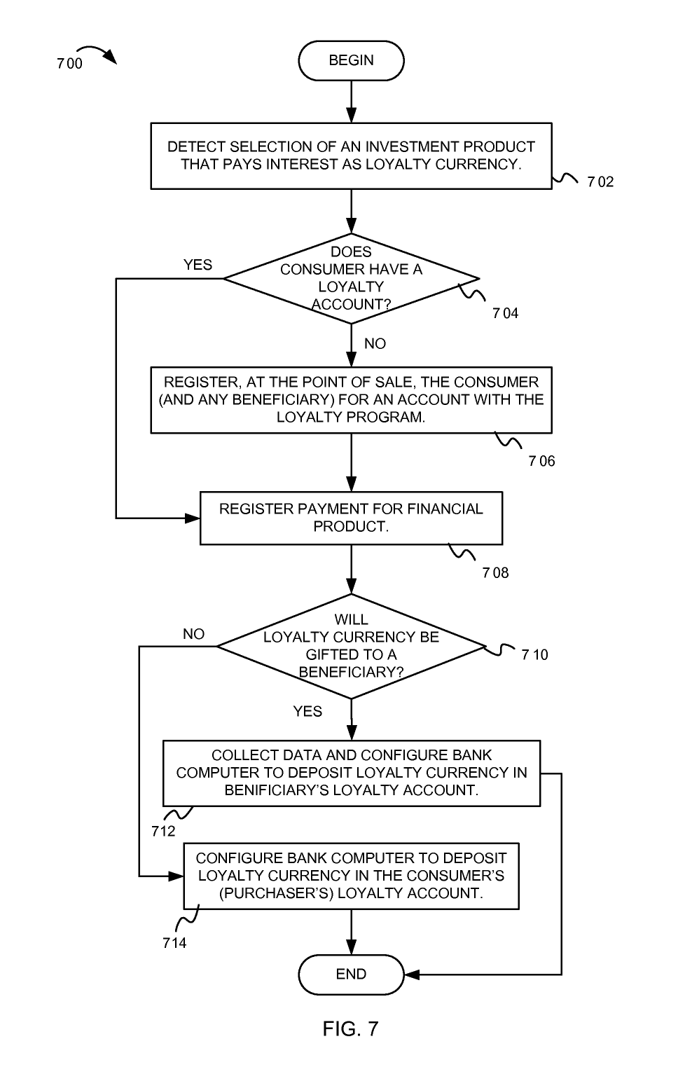

FIG. 7 is a flow diagram illustrating operations for selling investment products, according to some embodiments of the invention. In FIG. 7, the operations conduct a purchase transaction involving investment products that pay interest in the form of loyalty currency. In some instances, the operations may be performed in a bank (e.g., at a service counter with a teller and consumer). In other instances, consumers can interact directly with banking servers via webpages and personal computing devices.

In FIG. 7, the flow 700 begins at block 702. At block 702, a banking server detects selection of an investment product that pays interest as loyalty currency. For example, as part of a process for selling an investment product to a consumer, a bank teller selects, in a user interface hosted by a banking server, an investment product. As noted above, the investment product may be a certificate of deposit, annuity, or any other investment product described herein. The flow continues at block 704.

At block 704, a banking server determines whether a consumer has an account with a loyalty program. If the consumer does not have a loyalty program account, the banking server registers the consumer for an account with the loyalty program (see operation at block 706). In some embodiments, the banking server can register consumers without redirecting users (e.g., bank service personnel and/or consumers) outside the banking server's interface. That is, the banking server's user interface supports selection and sale of investment products, and it supports registering consumers for loyalty program accounts. To accomplish such support, the banking server can convey consumer information to a loyalty program server. In response, the loyalty program server can notify the banking server whether accounts have been successfully created. Thus, the banking server can facilitate operations for registering consumers for loyalty program accounts.

If the consumer already has an account, the flow skips block 706 and continues to block 708.

At block 708, the banking server records payment for the investment product. For example, if the point of sale is in a bank, a bank teller enters information indicating payment has been received. In other instances, such as web-based transactions that do not include service personnel, the banking server can receive payment electronically, such as via electronic funds transfer, credit card payment, etc. The flow continues at block 710.

At block 710, the banking server determines whether the consumer will be gifting loyalty currency that was earned as interest from the investment product. If the consumer will be gifting loyalty currency, the flow continues at block 712. Otherwise, the flow continues at block 714.

At block 712, because the consumer will be gifting loyalty currency, the banking server collects data about a beneficiary, and configures itself to provide the loyalty currency to the beneficiary after the interest accrues. In some instances, the banking server can record a message that will appear on the beneficiary's boarding pass, purchase receipt, and/or other documentation associated with redemption of the loyalty currency. Alternatively, the banking server or service person can prompt the consumer to provide one or more messages at a webpage hosted by the loyalty program computer (i.e., the loyalty program's website).

If the beneficiary does not have an account with the loyalty program, the banking server can facilitate creation of such an account, as similarly described in block 706. In some instances, the banking server allows the consumer to gift only a portion of the total loyalty currency earned as interest, depositing the remaining loyalty currency in the consumer's loyalty account. The banking server can deposit loyalty currency by communicating with a loyalty program server (see discussion of block 714 below). For embodiments where interest is paid as a travel package, the banking server can instruct the loyalty program server to provide the travel package. From block 712, the flow ends.

At block 714, because the consumer will not be gifting loyalty currency, the banking server configures itself to deposit loyalty currency in the consumer's loyalty program account. To deposit the loyalty currency, the banking server transmits a message to the loyalty program server, where the message requests such a deposit. In some instances, the deposit request is much like an electronic funds transfer because the bank is transferring its loyalty currency (e.g., purchased as described in FIG. 1) to the consumer. That is, the banking server is requesting transfer of loyalty currency from the bank's loyalty account to the consumer's loyalty account. The bank's loyalty account may be an administrative account that differs from typical consumer accounts. From block 714, the flow ends.

### Gifting and Messaging

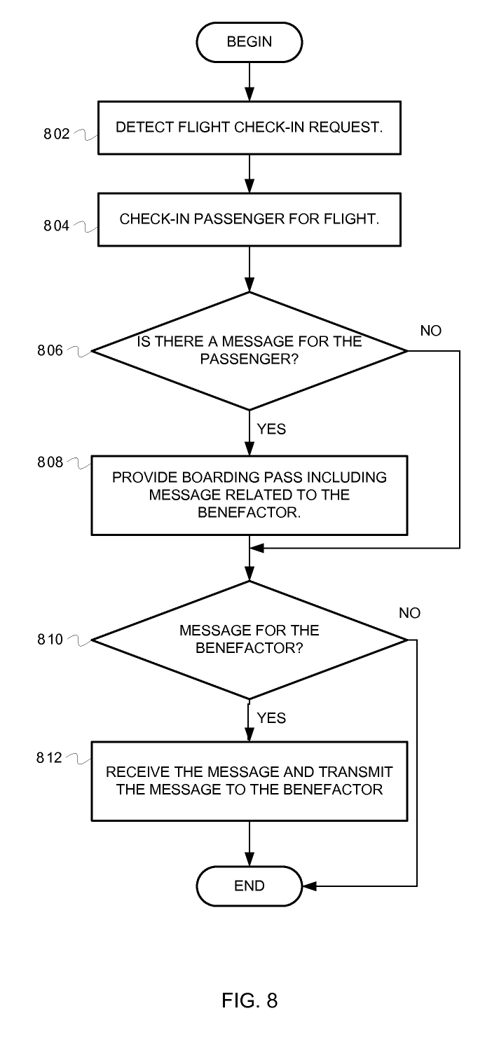

As described above, consumers may want to give away their loyalty currency to family members, friends, or other beneficiaries. Loyalty programs and their partners (e.g., airlines) benefit by supporting gifting, as gifting increases loyalty program membership, and builds loyalty to particular loyalty program partners. Consumers also derive benefits from giving away loyalty currency. For example, consumers may give away loyalty currency to personally reunite with loved-ones, or to feel satisfaction associated with giving gifts. To enrich the gifting experience, some embodiments facilitate messaging between benefactors and beneficiaries. For example, some embodiments print gift messages on boarding passes and send SMS text messages when passengers interact with airline computers. However, other embodiments facilitate messaging for airline tickets that were not purchased with gifted loyalty currency. The following discussion of FIG. 8 describes how some embodiments facilitate messaging.

FIG. 8 is a flow diagram illustrating operations for delivering messages based on airline information and information associated with a loyalty program. More specifically, the operations describe how airline servers and kiosks detect passenger activities, and provide messages from benefactors and friends.

In FIG. 8, a flow diagram 800 begins at block 802. At block 802, an airline check-in kiosk (e.g., in an airport) detects a passenger's request check-in for a flight. In some instances, an airline server (and not the kiosk) receives the check-in request over the Internet from a passenger who has not yet arrived at the airport. The flow continues at block 804.

At block 804, the airline server checks-in the passenger for the flight. The flow continues at block 806.

At block 806, the airline server determines whether there is a message for the passenger. As described in the discussion of FIG. 7, benefactors can provide messages that will be presented on a beneficiary's boarding pass. In some instances, the loyalty program server stores message information, while in other instances the airline server or other components may store message information. In some embodiments, the loyalty program server has social networking capabilities, such as allowing account holders to create social contacts, exchange messages, etc. In other embodiments, social contacts from non-loyalty-related social networking websites can enter messages for the passenger. Thus, the passenger's social contacts (from the loyalty program or otherwise) can record messages that will be presented on the passenger's boarding pass. The airline server can interact with the loyalty program server and other computing devices to determine whether there is a message for the passenger. If there is no message for the passenger, the flow continues at block 810. Otherwise, the flow continues at block 808.

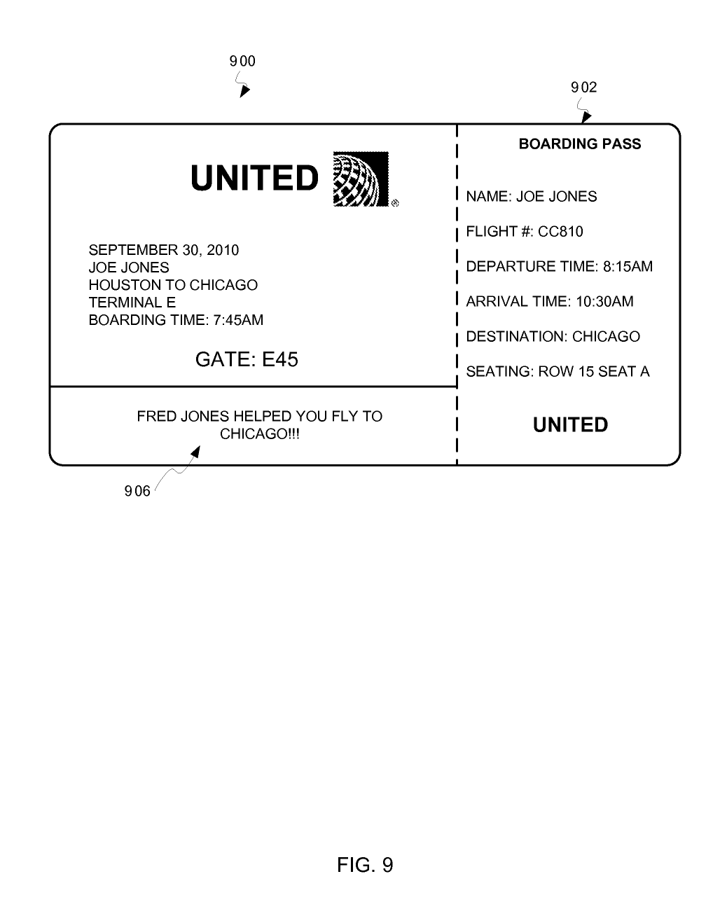

At block 808, the airline check-in-and kiosk provides a boarding pass including the message. FIG. 9 illustrates a boarding pass that includes a message from a benefactor or other social contact. In FIG. 9, the boarding pass 900 includes standard flight information such as departure date, passenger name, departure airport, arrival airport, boarding time, etc. The boarding pass 900 also includes a detachable portion 902, which the passenger carries onto a plane. Additionally, the boarding pass 900 includes a message area 906 in which the check-in kiosk prints a message from a benefactor or other social contact. In some instances, the message region resides on the detachable portion 902.

Although some embodiments print messages on boarding passes, other embodiments deliver the message by other facilities, such as email, text message (e.g., via Short Messaging Service protocol), voice message, etc. In some embodiments, even if there is no message, the kiosk notifies a benefactor or social contact that the passenger has checked-in for the flight. Such a notification may prompt the benefactor or social contact to contact the passenger via phone, text, etc. The flow continues at block 810.

At block 810, the airline check-in kiosk determines whether the passenger wants to leave a message for the benefactor or other social contact. If the passenger does not want to leave a message, the flow ends. Otherwise, the flow continues at block 812.

At block 812, the airline check-in kiosk detects a message from the passenger. For example, the kiosk may present a touch-screen keyboard or other input device with which the passenger can enter a message. Alternatively, the kiosk may present a list of pre-recorded messages from which the passenger can choose. After detecting the message, the kiosk can transmit the message to the benefactor or other recipient. In some instances, the kiosk transmits the message via SMS, e-mail, voicemail, or any other suitable messaging paradigm. From block 812, the flow ends.

While some embodiments can provide messaging on boarding passes, other embodiments can provide messaging on retail receipts and other sales documents. For example, in some instances, a retail server at a point of sale can perform operations similar to those in FIG. 8. Thus, the retail server can query the loyalty server for messages, and print those messages on a retail receipt.

### Additional Embodiments

### Investment Products

The investment products discussed herein can include any suitable investment products. In some embodiments, the investment products include, but are not limited to the following:
Interest-Bearing Investment Accounts—Interest-bearing investment accounts can include interest-bearing checking, savings, and money market accounts that periodically pay interest based on account balances. In some embodiments, a consumer “purchases” an interest-bearing investment account by opening the account and depositing money into the account. Interest earned from the deposits will be paid, at least in part, in the form of loyalty currency.
Annuities—Annuities provide periodic payments based on an initial investment. Some portion of each periodic payment constitutes interest for the initial investment. Therefore, the bank may deliver part of the annuity payment in cash, and another part in loyalty currency. However, the bank may deliver entire annuity payment as loyalty currency.
Investment Funds—Investment funds (e.g., mutual funds, managed funds, hedge funds, etc.) pool monies from numerous investors, and invest the monies in various securities. According to some embodiments, gains from investment funds will be paid as loyalty currency. In some instances, banks do not manage such investment funds. Instead, the bank forwards the consumer's investment to an independent investment fund, and later determines gains and losses. If the fund makes gains, the bank pays gains, at least in part, in the form of loyalty currency. Although the discussion above refers to investment products that pay “interest,” some embodiments may offer products that do not accrue interest. Thus, for some embodiments, the term “interest” refers to investment gains.

### Interest

The various embodiments of the inventive subject matter can compete interest according to any suitable interest formula, such as formulas for simple interest and/or compound interest. Interest rates can be fixed, variable, and some combination of fixed and variable.

### General

This document refers to various computers as “servers.” Although these servers may operate according to a “client-server” architecture, such operations is not necessary. Thus, any of the servers described herein can operate in any fashion capable of performing the operations described herein.

This document describes numerous details about embodiments of the invention. However, some embodiments may be practiced without these specific details. In some instances, for sake of clarity, this description omits well-known circuits, structures, and techniques. In this document, references to “some embodiments” or “an embodiment” mean that an operation or structure is included in at least one embodiment of the invention. Furthermore, separate references to “an embodiment” do not necessarily refer to the same embodiment. Thus, the present invention can include any combination of the operations, structures, and concepts described herein.

1. A method comprising:
detecting, by one or more banking servers, selection of an investment product, wherein the investment product pays interest according to terms of the investment product;
selling the investment product, wherein the selling includes,
receiving personal information about a purchaser of the investment product, wherein the personal information identifies a loyalty program account;
receiving, by the one or more banking servers, payment information indicating payment was received for the investment product;
determining, by the one or more banking servers, an interest value for the investment product based on the terms of the investment product; and
requesting transfer of loyalty currency into the loyalty program account, wherein the loyalty currency is valued at the interest value, and wherein the requesting transfer is performed by the one or more banking servers.

2. The method of claim 1, wherein the determining the interest value, and the requesting the transfer of loyalty currency occur periodically, according to the terms of the investment product.

3. The method of claim 1, wherein the investment product includes at least one of an investment fund, an interest bearing account, an annuity, a certificate of deposit.

4. The method of claim 1 further comprising:
registering the purchaser for the loyalty program account, wherein the registering is performed by the one or more banking servers, and wherein the loyalty program account is hosted by a loyalty program server.

5. The method of claim 1, wherein the terms indicate an initial investment, interest rate, and duration of time in which interest accrues.

6. The method of claim 1, wherein the loyalty account is owned by a beneficiary named by the purchaser.

7. The method of claim 6 further comprising:
recording, in the one or more banking servers, a message from the purchaser to the beneficiary; and
forwarding the message to a loyalty server.

8. A computer-implemented method for checking-in a passenger for an airline flight, the method comprising:
detecting, by one or more computers, a request to check-in the passenger to the airline flight;
checking-in, by the one or more computers, the passenger to the airline flight;
detecting a message for the passenger, wherein the message is from a benefactor who gifted the passenger loyalty currency with which the passenger purchased a seat on the airline flight;
printing a boarding pass for the airline flight, wherein the boarding pass includes the message for the passenger.

9. The method of claim 8 further comprising:
receiving, by the one or more computers, user input indicating a message from the passenger to the benefactor;
transmitting the message to the benefactor.

10. The method of claim 8 further comprising:
receiving the message from a loyalty program server.

11. The method of claim 8 further comprising:
notifying the benefactor that the passenger has checked-into the airline flight.

12. The method of claim 8, wherein the one or more computers include an airline check-in kiosk located at an airport.

13. The method of claim 8, wherein the one or more computers include an airline server providing a web page for receiving the request to check-in the passenger.

14. A system comprising:
a loyalty program server configured to
exchange sales information with a financial institution computer, wherein the sales information includes information about selling loyalty currency to a financial institution;
exchange interest accrual information with the financial institution computer, wherein the interest accrual information indicates amounts of loyalty currency to add to consumer loyalty accounts, wherein the amounts of the loyalty currency are for interest earned from financial products;
add the amounts of the loyalty currency to the customer loyalty accounts in response to the interest accrual information.

15. The system of claim 14, wherein the loyalty program server is further configured to:
receive messaging information from the financial institution computer, wherein the messaging information includes a message to be presented to a holder of a loyalty account; and
transmit the message for presentation on an airline boarding pass.

16. The system of claim 14, wherein the loyalty program server is further configured to:
receive messaging information from the financial institution computer, wherein the messaging information includes a message to be presented to a holder of a loyalty account; and
transmit the message for presentation on a purchase receipt at a point of sale.

17. The system of claim 14 further including the financial institution computer, wherein the financial institution computer is configured to:
present product information about the financial products;
receive consumer information about purchasers of the financial products, wherein the consumer information includes one or more beneficiaries identified by the purchasers, and wherein the one or more beneficiaries own one or more of the customer loyalty accounts.

18. The system of claim 17 further comprising an airline server configured to redeem the loyalty currency for airline tickets.

19. The system of claim 14, wherein the loyalty program server is further configure to: exchange airline information with an airline server, wherein the airline information includes information about airline tickets purchased by redemption of the loyalty currency and information about amounts of the loyalty currency to subtract from the customer loyalty accounts.

20. The system of claim 14, wherein the investment product includes at least one of an investment fund, an interest bearing account, an annuity, a certificate of deposit.
